(19) United States
(12) Patent Application Publication
(10) Pub. No.: US 2026/0079972 A1
(43) Pub. Date: Mar. 19, 2026

(54) SYSTEMS AND METHODS FOR DATA NAVIGATION

(71) Applicant: Schlumberger Technology Corporation, Sugar Land, TX (US)

(72) Inventors: Ginger Vinyard Hildebrand, Houston, TX (US); Juan Luis Benedicto Bravo Ramirez, Houston, TX (US); Peter Miller, Houston, TX (US); Ravi Chandran, Houston, TX (US); Carlos Garcia, Houston, TX (US)

(21) Appl. No.: 19/328,824

(22) Filed: Sep. 15, 2025

Related U.S. Application Data
(60) Provisional application No. 63/694,351, filed on Sep. 13, 2024.

(51) Int. Cl. G06F 16/3329; G06F 16/334; G06F 16/338

(52) U.S. Cl. CPC G06F 16/3329; G06F 16/334; G06F 16/338

(57) ABSTRACT

A system, includes a processing system comprising an artificial intelligence (AI) engine. The processing system is configured to receive a set of data from a data source, divide the set of data into one or more subsets of data, transmit the one or more subsets of data to the AI engine, transmit one or more queries to the AI engine to elicit search and identification of one or more responses based on a data set comprising the one or more subsets of data, wherein the one or more responses include a text-based response and a graphical response associated with the text-based response, and transmit the text-based response and the graphical response to a graphical user interface for presentation on a display of an electronic device comprising the graphical user interface.

This application is a Non-Provisional Application claiming priority to U.S. Provisional Patent Application No. 63/694,351, entitled “SYSTEMS AND METHODS FOR DATA NAVIGATION”, filed Sep. 13, 2024, which is herein incorporated by reference.

### BACKGROUND

The present disclosure generally relates to systems and methods for navigating data associated with natural resource operations.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Generally, entities are becoming increasingly interested in feedback during operations such as building, maintaining, repairing, and otherwise servicing equipment, construction of facilities, and many other operations, such as natural resource drilling operations. However, it may be difficult to retrieve, manage, and/or summarize available data due to large volume and/or complexity of the data. Further, visualization and/or navigation of the data by a user may be inefficient. For example, in the relationship between an oilfield services provider and their customer, the customer may want to access certain information about oilfield services and/or equipment that they have ordered in the past, are awaiting delivery, or are currently being delivered. However, this information might be maintained by the oilfield services provider in multiple databases. It would be beneficial to have a way to combine this data and make it available to customers in an efficient manner to allow customers and the service provider to interact with and understand. That is, it may be desired to improve data management, navigation, summarization, and/or visualization.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a flow diagram of processes performed in a navigation system, in accordance with an embodiment of the present disclosure;

FIG. 2 is a flowchart of a method for providing one or more subsets of data for processing, in accordance with an embodiment of the present disclosure;

FIG. 3 is a flowchart of a method for generating a response to a query, in accordance with an embodiment of the present disclosure;

FIG. 4 is first view of a graphical user interface (GUI) usable in conjunction with the navigation system of FIG. 1, in accordance with an embodiment of the present disclosure;

FIG. 5 is second view of a graphical user interface (GUI) usable in conjunction with the navigation system of FIG. 1, in accordance with an embodiment of the present disclosure; and

FIG. 6 is third view of a graphical user interface (GUI) usable in conjunction with the navigation system of FIG. 1, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

In addition, as used herein, the terms “real-time”, “real-time”, or “substantially real-time” may be used interchangeably and are intended to described operations (e.g., computing operations) that are performed without any human-perceivable interruption between operations. For example, data relating to the systems described herein may be collected, transmitted, and/or used in control computations in “substantially real-time”, such that data readings, data transfers, and/or data processing steps may occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, solely by analysis system without human intervention.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

The present embodiments described herein include a navigation system, which navigates data of one or more entities by retrieving, grouping, and/or processing a set of data to provide one or more responses to one or more queries. The navigation system retrieves (e.g., receives, fetches) the set of data from one or more of a variety of data sources (e.g., one or more industrial machines, sensors, controllers, one or more databases, etc.) associated with one or more industrial operations, for example, natural resource operations, such as drilling operations. This retrieval can be repeated for additional data sources. The set of data may be associated with one or more metrics of each respective data source. For example, the navigation system may receive one or more portable document formats (PDFs) or other formatted data associated with each respective data source. Further, the navigation system may continuously monitor the one or more data sources for updates to the set of data, ensuring the set of data maintains relevance.

The navigation system may then split and/or group the data into one or more subsets of data. This can include assigning identifiers to the data that operate as permissions for access to the data and/or may tag the subset as being associated with a particular data source. The navigation system may then group the one or more subsets of data based on a template (e.g., a set of sequenced questions, instructions, or the like). In some embodiments, the template may be based on the type of data being grouped, access permissions, and/or additional attributes. In other embodiments, a user or a developer may customize the template via one or more user inputs. In this manner, implementation of the template may enable a user-guided bias toward specific data types and results. As such, the navigation system may pre-process the data via retrieval, extraction, split, and grouping and provide one or more subsets of data for processing.

The navigation system may process the one or more subsets of data via an artificial intelligence (AI) engine based on one or more user inputs. The navigation system may include a user interface, which enables a user to input one or more queries into the navigation system. Thus, the navigation system may receive the one or more user queries associated with navigation (e.g., data navigation). For example, the navigation system may process a query via the AI engine and identify a portion of the one or more subsets of data (e.g., a portion of data of the one or more subgroups) based on the query. The navigation system may then generate a response to the one or more queries based on the identified portion of the one or more subsets of data. Further, the navigation system may provide the generated response for visualization via a display of the user interface. This generated response can include both text and graphical elements that visually represent the same or corresponding information to that provided in the text response. In this manner, the navigation system may improve data management, navigation, and/or visualization by efficiently gathering, grouping, and/or presenting the data based at least on the one or more user queries. Additional descriptions of the data management, navigation and/or visualization may be obtained by reference to U.S. patent application Ser. No. 18/820,414 filed Mar. 28, 2024, the disclosure of which is incorporated by reference as if fully set out at this point, by reference to U.S. Provisional Patent Application Ser. No. 63/571,189 filed Aug. 30, 2024, the disclosure of which is incorporated by reference as if fully set out at this point, and by reference to U.S. Provisional Patent Application Ser. No. 63/694,314 filed Sep. 13, 2024, the disclosure of which is incorporated by reference as if fully set out at this point.

Present embodiments may have value in various industries. For example, many oilfield services and equipment rest on certain key performance indicators (KPIs), such as run life, speed, and/or other operational data. Customers may find it helpful to review information (e.g., data) when selecting equipment and/or services to gain confidence in their selection. Additional information can be useful, for example, where a particular configuration or critical component has been used and what the resulting KPIs have been. Additionally, when an incident (e.g., an early or unexpected failure) is encountered, it would be beneficial to those compare the results (data) from the operation and/or component that failed to other data (e.g., offsets) to assist in determining whether the incident was an isolated issue or part of a trend. This information can be useful in making decisions on (e.g., predicting the need for) replacements and future installations on other wells in a given area (e.g., a field).

The aforementioned information would be beneficial for users that work as a customer lead or customer engagement representatives, since they design and/or present customer solutions. The information would also be useful for users of devices employed in operations (e.g., pumps, drill bits, etc.), so that the users could interface with technical information on components used in particular operations. Present embodiments provide for the customizable scoping of data to authorized users and presentation of relevant data that includes both textual and graphical responses to queries by respective users for performance and/or operations data. Additionally, and/or alternatively, the present embodiments provide for the customizable scoping of data to authorized users and presentation of relevant data as including audio and/or video responses (in addition to or in place of textual and graphical responses) to queries by respective users for performance and/or operations data.

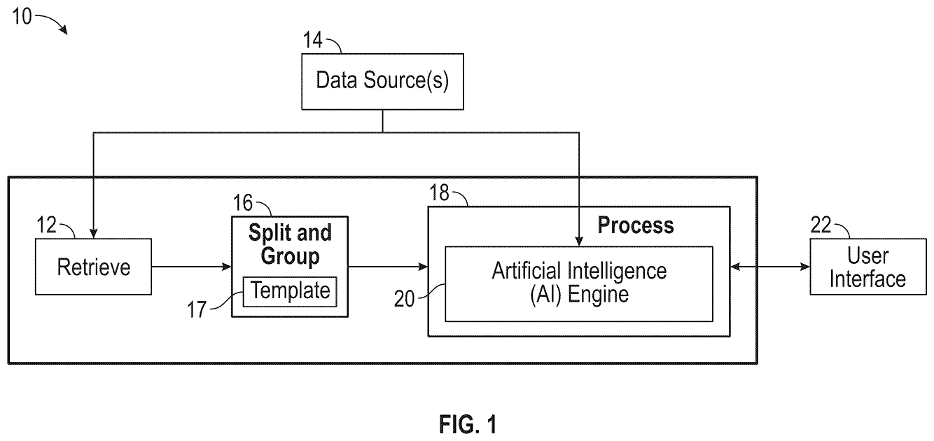

With the foregoing in mind, FIG. 1 is a flow diagram of processes performed in a navigation system 10 (i.e., a data navigation system), in accordance with an embodiment of the present disclosure. In some embodiments, the navigation system 10 may include a processing device (e.g., processing circuitry, processing system, etc.) with at least a processor capable of executing computer-executable code to perform the operations described below. The processing device of the navigation system 10 may operate in conjunction with a deep-learning processor or a neural-network processor and/or, for example, the processing device may include machine learning and/or artificial intelligence (AI)-based processors.

For example, in one or more embodiments, a deep-learning processor or a neural-network processor, and/or, for example a machine learning (ML) and/or AI based processor of the navigation system can execute instructions stored in memory and/or storage of the navigation system as one or more analysis modules to execute one or more of the operations described herein. Likewise, the operations described herein may be instituted via a processing device (e.g., processing circuitry, processing system) with at least a processor capable of executing computer-executable code to perform the operations described herein via a local computing device and the AI functions described herein can be performed on a server or in the cloud as coupled to the local computing device of the navigation system. In some embodiments, a processing device of the navigation system 10 may operate in conjunction with a deep-learning processor or a neural-network processor and/or, for example, the processing device may include machine learning and/or artificial intelligence (AI)-based processors.

Therefore, the AI may be integrated into the navigation system 10 (or remotely coupled thereto) and can operate as a component that utilizes algorithms and/or models interconnected with other components of the navigation system 10. In some embodiments, the AI may function separately (e.g., independently) from the navigation system 10. Further, the AI may be coupled to the navigation system 10 via a cloud (e.g., a cloud-based integration) enabling utilization of the algorithms and/or the models hosted remotely on the cloud. The navigation system 10 may also include memory and/or storage, which may be any suitable articles of manufacture that serve as media to store processor-executable code, data, or the like. These articles of manufacture may represent computer-readable media (e.g., any suitable form of memory or storage) that may store processor-executable code used by the processor to perform the below noted techniques. It should be noted that the navigation system 10 may perform at least some of the processes described herein in parallel (e.g., simultaneously) or at separate times.

In block 12, the navigation system 10 may retrieve a set of data from one or more data sources 14. The data sources 14 can be associated with one or more entities. For example, the one or more entities may include companies in the oil and gas industry, companies in the construction industry, companies in the cement industry, companies in manufacturing industry, etc. Alternatively, the data sources 14 can be associated with a single entity in control of a particular operation. The one or more data sources 14 may include one or more application programming interfaces (APIs), one or more sensors, one or more controllers, one or more databases, and/or other similar data gathering and/or storage sources. As an example, the navigation system 10 may receive one or more portable document formats (PDFs) or other formatted data and/or raw data from each respective data source. It should be noted that the navigation system 10 may employ data scraping regularly (e.g., continuously, at intervals) automatically and/or at one or more defined times (e.g., predetermined scheduled times, which can be set by a user or automatically generated) to retrieve data from the one or more data sources 14. Alternatively, the data may be transmitted automatically and/or at one or more defined times (e.g., predetermined scheduled times) from the respective data sources 14 to the navigation system.

In some embodiments, retrieval of data from the one or more data sources 14 can be in response to a request from the navigation system 10 and refresh operations (i.e., scheduled retrievals of data from the one or more data sources) can be performed at the same frequency or at differing frequencies relative to one another. For example, the navigation system 10 may employ data scraping to enable use of data that is up to date (e.g., current). Additionally, for example, the navigation system 10 may employ a minimum refresh frequency of the one or more data sources 14 at least once daily or any other suitable time period (e.g., hourly, weekly, monthly), whereby the refresh frequencies may be common between the one or more data sources 14 or may differ therebetween.

In block 16, the navigation system 10 may extract (e.g., split) relevant information, such as particular metrics, from the set of data. Examples of types of relevant information and/or metrics can include one or more of, operational results, performance data, failures, and/or other metrics. The extraction of the relevant data can be accomplished via a command transmitted to the program or an AI model trained to detect objects, for example, in images (e.g., a computer vision model). Additionally and/or alternatively, the extraction of the relevant data can be accomplished via an executed code that instructs the computer vision model to extract the relevant information, for example, through the use of a template 17 (e.g., a set of sequenced questions, instructions, or the like) generated for the particular relevant information extraction.

In this manner, the relevant information may include at least a portion of the set of data. That is, the navigation system 10 may extract relevant text and/or images from the set of data. To assist in accomplishing the extraction, the navigation system 10 may employ as noted above, for example, a computer vision model, which may process images using deep learning techniques (e.g., a neural network or AI on a local device of the navigation system or connected thereto and hosted in a remote server, in the cloud, etc.) to extract one or more features from the data, for example an ASCII (e.g., textual version) of the retrieved data from block 12. As another example, the navigation system 10 may employ a computer-based vision technique, such as optical character recognition (OCR) to extract images and/or text from the data associated with each respective entity. After extraction of the relevant information from the set of data, the navigation system 10 may assemble (e.g., compile, combine) the extracted set of data into a particular format.

Additionally in block 16, the navigation system 10 may group the extracted set of data. For example, the navigation system 10 may employ a computer algorithm that separates particular data included in the set of data while maintaining consistency (e.g., by operation, component, organization, location and/or other commonality in aspects of the data) of the underlying data. For example, the navigation system 10 may divide the extracted set of data into one or more subsets of data (e.g., one or more portions of the data received from the sources 14). The subset of the data (or the data in a particular subset) can include one or more indications that correspond to the data in the subset (e.g., the data in the subset is tagged). The identifications can, for example, correspond to classifications of the data. These classifications may be used to identify which data will be accessible by an AI model when responding to a query. In some embodiments, the identifications can correspond to an organization that owns and/or generated the data, a location associated with the data, a component associated with the data, a project and/or operation that generated the data, and/or other identifying characteristics that correspond to the respective data of the subset.

Thus, in some embodiments, the navigation system 10 may assign an identifier to each of the one or more subsets of data based on an associated data source (e.g., an associated entity). Likewise, additional identifiers can be assigned to particular data of each of the one or more subsets of data to identify data with common aspects. For example, the navigation system 10 may assign a respective identifier to each of the one or more subsets of data based on an entity, an industry, and/or history associated with each of the one or more subsets of data. It should be noted that the identifiers may be identical, a portion of the identifiers may be identical, or each identifier may be entirely distinct (e.g., different). For example, one portion of the one or more subsets of data may be associated with a particular entity, a particular project or operation, and/or a particular component. Thus, for example, one identifier for a respective entity (e.g., an entity identifier) associated with a subset of data can be utilized identifying the data as corresponding to a data source 14 for that entity can be applied to all split data for that entity to track the splits of data. Likewise, another portion of the one or more subsets of data may be associated with another particular entity. Thus, a different (entity) identifier for that other entity identifying the data as corresponding to a data source 14 for that other entity can be applied to all split data for that other entity to track the splits of data.

In this manner, the navigation system 10 may reduce an output size of the extracted set of data during the split and group process for input into an AI model (e.g., generative AI model), such as a Retrieval-Augmented Generation (RAG) model as the AI model, while also maintaining organization when storing the extracted set of data (e.g., in a memory of the navigation system 10 or any other suitable memory).

To group the extracted set of data, the navigation system 10 may employ an AI model (e.g., a generative model) or an algorithm to perform grouping tasks. For example, the navigation system 10 may employ the AI model to perform searching on the extracted set of data and group the extracted set of data while only accessing particular data that is authorized for use by a particular user (i.e., data that has one or more identifiers that mark the data as usable in answering a user query). In generating the subsets of data, the template 17 can be utilized. It should be noted that the template 17 may include processor-executable code that may be executed by the processor device of the navigation system 10 to direct the AI model to split the extracted set of data and/or to group the one or more subsets of data. As such, the navigation system 10 may employ the template 17 to generate the grouped one or more subsets of data. As an example, the template 17 may be customized based on the one or more user inputs that specify a type of data to be grouped. In some embodiments, the user may run one or more queries via a customized template 17.

In block 18, the navigation system 10 may process the one or more subsets of data via an AI engine 20 (e.g., AI system), which may employ an AI model (e.g., the same AI model described above with respect to block 16 or a separate AI model with both or either local to the computing device of the navigation system 10 or remotely connected thereto and present in a server, the cloud, or the like). In one embodiment, the navigation system 10 may input the one or more subsets of data into the AI engine 20 to adjust (e.g., refine, fine-tune) the AI model based on the one or more subsets of data and/or enable query of the one or more subsets of data. Accordingly, the navigation system 10 may provide an output via the AI engine 20 in a format that aligns with requested (e.g., desired) output parameters for a model optimization scheme. Indeed, the output parameters may be requested by the user via one or more inputs to the navigation system 10.

In some embodiments, the navigation system 10 may store the processed data in the memory (e.g., within a database) of the navigation system 10 or any other suitable memory to enable efficient retrieval and analysis of data at subsequent times. Further, in some embodiments, the navigation system 10 may incrementally develop and/or store the data after processing to facilitate efficient retrieval and analysis of the data at the subsequent times. In other embodiments, the AI engine 20 may store the processed data. In addition, a retrieval component of the AI engine 20 may be customized (e.g., via the one or more user inputs) to query the one or more data sources. Indeed, the retrieval component of the AI engine 20 may be customized to search, identify, and/or separate (e.g., partition) data based on an associated entity, project, location, operation, process, component, etc. and respond to one or more user queries utilizing authorized data or authorized and relevant data.

Indeed, in block 22, the navigation system 10 may receive the one or more queries (e.g., one or more user inputs) associated with data navigation via a user interface apart from or in communication with the navigation system 10. The user interface may be presented to the user via a display (e.g., an electronic display) of the navigation system 10, or any other suitable display as part of or in communication with (e.g., wired or wirelessly) the navigation system 10. In some embodiments, the user interface may be presented via a computing device (e.g., in communication with the navigation system 10) of the user. It should be noted that the one or more queries may be input in a natural language form (e.g., conversational form). In some embodiments, the user interface may correspond to a graphical user interface (GUI) operating in conjunction with one or more physical inputs (e.g., keyboard, mouse, touchscreen) as displayed on a device (i.e., a device coupled to the navigation system 10 either wirelessly or via a wired connection for communication and/or data transfer therebetween or a device as part of the navigation system 10).

As described above, the navigation system 10 may employ the AI engine 20 to search for and identify (e.g., navigate) a portion of the one or more subsets of data and generate one or more responses to the one or more queries based on the portion of the one or more subsets of data. For example, the user may input a query via the user interface requesting operating statistics or results of an operation. The navigation system 10 may employ the AI engine 20 to search each of the one or more subsets of data, identify the portion of the one or more subsets of data associated with the operation and tagged (identified) as being allowable data for transmission, and generate a response to the query using the allowed and found data. It should be noted that the AI engine 20 may enable search and identification of the portion of the one or more subsets of data in real-time. That is, the retrieval component of the AI engine 20 may access the data efficiently in real-time via a middleware layer (e.g., a software that acts as an intermediary between a number of systems or applications to facilitate communication and data exchange) that performs translation between retrieval queries of the AI engine 20 and queries of the one or more data sources 14 (e.g., using structured query language (SQL) or particular APIs). In doing so, the AI engine 20 operates to perform operations in a manner that without user input and in an amount of time that is not practicable to be performed in the human mind. Additionally, the navigation system 10 may provide the generated response to the user. It should be noted that while the navigation system 10 is described as receiving data related to operations or projects, any other suitable type of data from any suitable industry may be received and employed by the navigation system 10 to perform any suitable type of data navigation (e.g., of any other suitable data). For example, the types of data may include sales data, financial data, or the like in addition to or in place of operational data.

Furthermore, the AI engine 20 may also use an agentic assistant, such as the Retrieval Augmented Generation (RAG) bot, to generate a response to a query using the extracted context. That is, the RAG bot may receive the query and use the knowledge base to determine the context (e.g., one or more vector embeddings in the vector databases) that may be provided to the AI engine 20 to generate a response to the query. The response may include a typographical answer, images, videos, documents and other enterprise resources, and the like. The AI engine 20 may then transmit the response to the user interface 22. In some embodiments, the AI engine 20 may adjust its knowledge base to improve performance over time. For example, the AI engine 20 may track the accuracy of responses to user queries and adjust its knowledge base based on accuracy metrics (e.g., user satisfaction, fallback to human-based support systems). In this way, the AI engine 20 system may become more accurate over time as it provides responses to user queries. According to these techniques, the AI engine 20 may generate timely and computationally efficient responses to queries that are tailored to the enterprise environment while maintaining data security. Automation of an AI workspace support with a domain-trained artificial intelligence system (e.g., the AI engine 20 as well as any agentic assistant, for example, a RAG bot) may provide continuous (e.g., 24-hour) personalized assistance that reduces resolution times, enhances consistency, and allow for individuals to address other tasks.

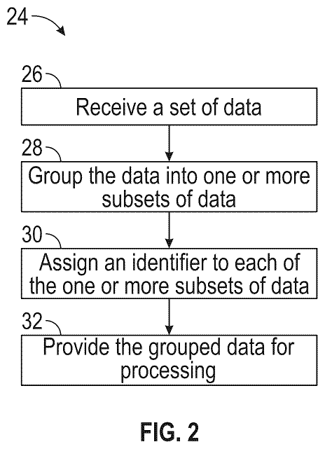

As described above, the navigation system 10 may split and group the data to enable input into the AI engine 20 and/or storage of the data via the memory of the navigation system or a memory of the AI engine 20. With this in mind, FIG. 2 is a flowchart of a method 24 for providing one or more subsets of data for processing, in accordance with an embodiment of the present disclosure. The workflow of FIG. 2 is an agentic workflow, which refers to a structured, multi-step process where the AI engine 20 operates autonomously (i.e., without human intervention) to handle complex tasks. It should be noted that one or more blocks of the method 24 need not necessarily be performed by the processing circuitry of the navigation system 10 and/or by the AI model (respectively) in the illustrated order. For example, one or more of the blocks of method 24 can be performed in parallel. That is, it should be understood that, though shown in a sequential or serial manner for the purpose of illustration and explanation, in practice certain of the blocks of method 24 may be performed in parallel or in a multithreaded manner, which may be more efficient in terms of time, computational cycles or bandwidth, and/or computational resources. Moreover, various blocks of the method 24 of FIG. 2 can be performed, for example, by the processing circuitry of the navigation system 10, which can operate in conjunction with a deep-learning processor or a neural-network processor and/or, for example, the processing circuitry may include machine learning and/or AI-based processors.

At block 26, the navigation system 10 may receive a set of data. For example, the navigation system 10 may receive the set of data via the one or more data sources 14. For example, the navigation system 10 may receive the set of data after extraction of the data. At block 28, the navigation system 10 may split (e.g., divide, partition) the set of data into one or more subsets of data as groups of data. Further, at block 30, the navigation system 10 may assign one or more identifiers (e.g., marker, tag) to each of the one or more subsets of data based on an associated data source (e.g., origin of the data, a respective entity, etc.). In some embodiments, at block 30, the navigation system 10 may assign the identifier to each of the one or more subsets of data based on a type of the data, an operation, a component, a location, or other identifying characteristics of the data shared amongst two or more data points of the data retrieved (or received) from the data sources 14. Assigning each of the subsets of data based on the associated data source, data type, entity, project, operation or the like may enable the navigation system 10 to maintain organization and traceability of each of the subsets of data. That is, by assigning the identifiers, the navigation system 10 may efficiently organize and categorize the one or more subsets of data for retrieval and processing. In some embodiments, the assigning of one or more identifiers (e.g., marker, tag) to each of the one or more subsets of data based on an associated data source (e.g., origin of the data, a respective entity, etc.) is performed in parallel with the may splitting (e.g., dividing, partitioning) of the set of data into one or more subsets of data as groups of data in block 28. In this manner, the navigation system operates in a manner that cannot be practically performed in the human mind, at least because the human mind is not equipped to perform the operations of blocks 28 and 30 at least, for example, in parallel.

As part of block 30, the navigation system 10 may group the one or more subsets of data based on a template 17. Indeed, the navigation system 10 may group the one or more subsets of data by employing the AI model to perform grouping tasks. The navigation system 10 may employ the template 17 based on one or more of the aforementioned common characteristics shared in data of the one or more subsets of data. The template 17 may guide the AI model by providing a structured format for input data, such as the one or more subsets of data. Indeed, the template 17 may enable the AI model to produce an expected output through pre-defined rules and/or patterns embedded within the template.

At block 32, the navigation system 10 may provide the grouped and identified one or more subsets of data for processing by the AI model (e.g., via the AI engine 20). By providing curated data as the grouped and identified one or more subsets of data for processing by the AI model, the navigation system 10 operates to provide the data in a manner that reduces resource consumption, for example, by the AI model, since the data has been collected in a manner that allows for greater efficiency in accessibility by the AI engine 20. It should be noted that the navigation system 10 may perform the method 24 iteratively any suitable number of times. For example, the user may create the template 17 that enables identification of data associated with a component of an oilfield operation. The navigation system 10 may perform the method 24 based on a set of data associated with the component. In addition, the navigation system 10 may perform the method 24 based on a set of data associated with an operation, for example, a drilling operation. The navigation system 10 may then perform the method 24 on the second set of data so that identified and grouped data is obtained and provided to the AI engine 20 for use in answering respective queries. Blocks 26, 28, 30, and 32 can be performed automatically as part of training the AI engine 20 and/or providing an accessible database of information for the AI engine 20. Furthermore, blocks 26, 28, 30, and 32 are performed without user input and in an amount of time that is not practicable to be performed in the human mind. Additionally, the disclosed embodiments include machine-generated data (or data sets) and machine-implemented data transformation, as well as subsequent transmission, which are distinct from any process previously performed by humans to provide searchable datasets for use by an AI engine.

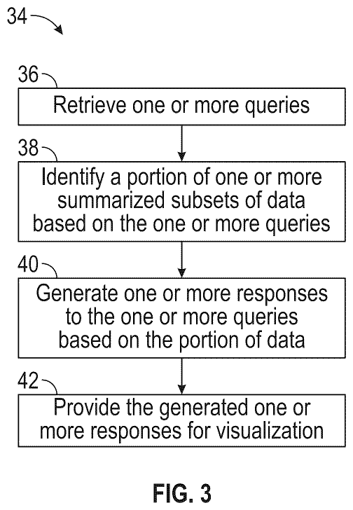

As described herein, the navigation system 10 may employ the grouped and identified subsets of data to navigate and generate responses to one or more queries. FIG. 3 is a flowchart of a method 34 for generating one or more responses to one or more queries, in accordance with an embodiment of the present disclosure. The workflow of FIG. 3 is an agentic workflow, which refers to a structured, multi-step process where the AI engine 20 operates autonomously (i.e., without human intervention) to handle complex tasks. It should be noted that one or more blocks of the method 34 may be performed by the processing circuitry of the navigation system 10 in any suitable order. For example, the processing circuitry of the navigation system 10 can operate in conjunction with a deep-learning processor or a neural-network processor and/or, for example, the processing circuitry may include machine learning and/or AI based processors. Additionally, it should be understood that, though shown in a sequential or serial manner for the purpose of illustration and explanation, in practice certain of the blocks of method 34 may be performed in parallel or in a multithreaded manner, which may be more efficient in terms of time, computational cycles or bandwidth, and/or computational resources.

At block 36, the navigation system 10 may receive one or more queries associated with data navigation. For example, the user may input a query via the user interface requesting data on the performance of an operation associated with the one or more grouped subsets of data. It should be noted that the user may request information associated with a particular entity and/or any number of entities of the one or more entities. However, access will be only provided based on user credentials and/or other criteria that authenticate a user as being authorized to receive information associated with a particular entity. The AI engine 20 will also only search data with an identifier that corresponds to authorized data viewable by a particular user. Thus, a user log in can determine the type of data that is retrievable by any query.

At block 38, the navigation system 10 may identify a portion of the one or more summarized subsets of data based on the one or more queries. That is, the navigation system 10 may employ the AI engine 20 to search each of the summarized subsets of data. It should be noted that the AI engine 20 may enable search and identification of the portion of the one or more subsets of data in real-time and the search and identification can be undertaken in parallel (i.e., parallel searches and/or identifications) by the AI engine 20. That is, the retrieval component of the AI engine 20 may access the data efficiently in real-time via a middleware layer (e.g., a software that acts as an intermediary between a number of systems or applications to facilitate communication and data exchange) that performs translation between retrieval queries of the AI engine 20 and queries of the one or more data sources 14 (e.g., using structured query language (SQL) or particular APIs). In doing so, the AI engine 20 operates to perform operations in a manner that without user input and in an amount of time that is not practicable to be performed in the human mind. Furthermore, one or more of the data sets that are accessed, searched, and/or identified by the AI engine 20 can include real-time data (e.g., operational data collected, sensed, or otherwise gathered during operations, such as natural resource drilling operations, production operations, or the like). Receipt and access of this real-time gathered data can be performed in parallel and use of the AI engine 20 to access this data allows for inclusion of data in generating results that additionally cannot be practically performed by a human. That is, in some embodiments, real-time data acquisition systems can operate as one of the data sources 14 and can transmit real-time data to the navigation system 10 for use by the AI engine 20 in a manner not performable by a human. Moreover, acquisition of real-time data at the navigation system 10 can be performed while additional data is being analyzed by the navigation system 10 (i.e., block 26 of method 24 can be performed as receiving real-time data at the same time that one or more of blocks 28, 30, and 32 are performed and this process can be iteratively repeated by the navigation system 10 as new real-time data is acquired), allowing the navigation system 10 and the AI engine 20 therein to function in a manner not able to be performed by a human.

For example, data may be acquired in a given field or other natural resource area having operations performed thereon. This data may be acquired via one or more real-time acquisition systems as data source(s) 14. The real-time acquisition sources can be, for example, monitoring aspects of a drilling operation and collecting data associated with the drilling operation in real-time. This data can be transmitted to the navigation system and used to update the data that is searchable by the AI engine 20 and usable to generate results in response to user queries, provide suggestions for subsequent operational decisions, etc. Likewise, the AI engine 20 can use data from a given field or other natural resource area having operations performed thereon to search for commonalities with respect to particular sites in the field (e.g., overlaps in performance of equipment, results of operations, etc.) and can provide generated results based on the searched data, which may have been received, collected, and/or updated in real-time and/or can be searched in conjunction with stored historical data also available to the AI engine 20. Moreover, the data received can be unstructured and in various forms including, for example, one or more of reports, sensor data, conversations, written notes, or other types of data.

Additionally, in some embodiments, the search is curbed by the authorization level of a user so that only authorized data is searched as part of the search of the subsets of data. As an example, the navigation system 10 may employ the AI engine 20 to identify the performance data associated with an operation at a particular location in a field as searchable data as a dataset to be searched in response to a query in block 38.

At block 40, the navigation system 10 may generate one or more responses to the one or more queries based on the identified portion of data (i.e., the authorized data and the data relevant to a query as a subset of the total authorized data from block 38). Further, at block 42, the navigation system 10 may provide the generated one or more responses for visualization via the display. For example, block 42 can be performed by updating a GUI of a device that includes the user interface of block 22. The generated responses can include a text portion. Additionally, the responses can include a graphical representation related to the text portion. In some embodiments one or more of audio and/or video responses (in addition to or in place of the textual and graphical responses) can be present as part of the generated responses. When present, the graphical representation (and/or the audio or video representation) can be dynamic, allowing for user interaction with the representation to more easily view aspects of the reported results of the query. As such, the navigation system 10 may efficiently generate and transmit results for presentation to a user via the GUI, thus allowing the user to navigate the responses to obtain particular information in a simple and efficient manner.

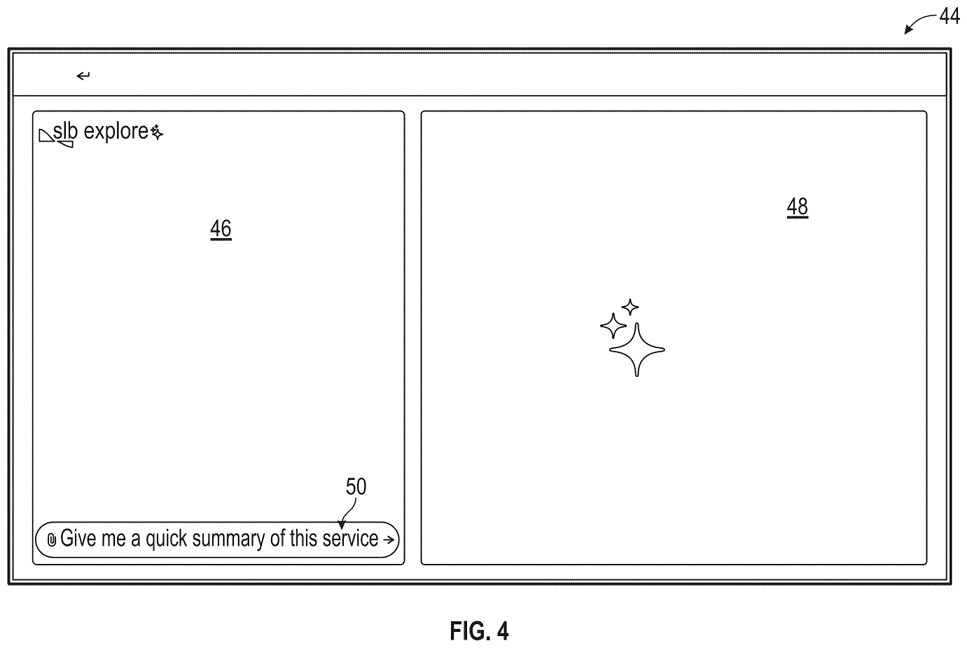

With the foregoing in mind, FIG. 4 is an example illustration of a first view of a GUI 44 usable in conjunction with the navigation system 10. The GUI 44 can be deployed on computing systems, for example, smart watches, smartphones, tablets, laptops, and/or other portable electronics. FIG. 4 illustrates an example of a view that a user would see subsequent to logging in or otherwise providing access credentials. As noted above, these access credentials can be matched to one or more identifiers in the subsets of data to restrict viewable (and searchable) data to subsets that are authorized given the access credentials of the user. Thus, a worker for an entity might have access to a portion of the data identified as corresponding to that entity. However, a foreman for that same entity (i.e., a user with a higher clearance level or otherwise identified with greater access to data for the entity) can be granted access (both for searching by the AI engine 20 and providing responses to queries) that exceeds that provided to the worker.

As illustrated, the GUI 44 provides a text-based window 46 and a graphical window 48. The text-based window 46 includes a text field 50. The text field 50 allows for a user to input a query. In some embodiments, the text field 50 can include an icon that when selected allows for transmission of the user inputted text in the text field to be transmitted to the AI engine 20 as a query. As illustrated in FIG. 4, the graphical window 48 may be empty. As will be discussed below, graphical window 48 may be populated with graphical representations that correspond to returned results from a user query (audio and/or video representations can also be generated and presented to the user). Thus, FIG. 4 illustrates an initial state in which no query has yet to be transmitted and searched by the AI engine 20.

The GUI 44 may thus allow a user to input the one or more queries and receive the one or more responses generated by the navigation system 10. Accordingly, the navigation system 10 may allow the user to efficiently query and/or visualize information associated with the one or more entities. For example, the user may input (e.g., via the text field 50) a request that allows for authorized data to be searched and reported. The user may input the request in a natural language form into text field 50. The navigation system 10 may employ the AI engine 20 to identify most relevant and authorized data to be represented in response to the query. In this manner, the navigation system 10 provides a flexible platform to provide up to date information that can be tailored to particular users.

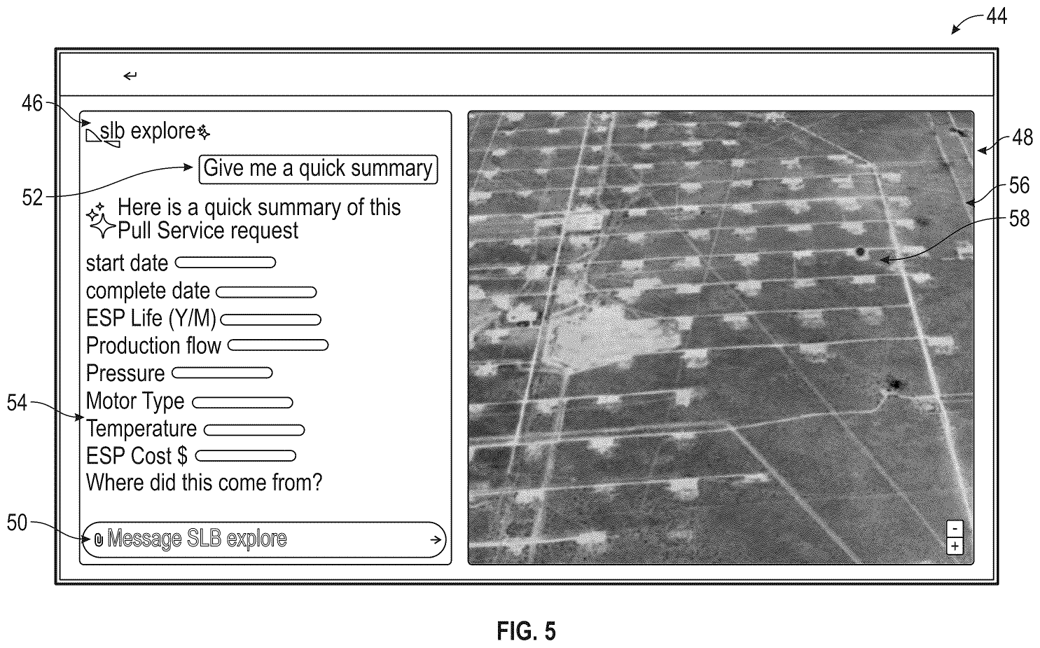

FIG. 5 is an example illustration of a second view of GUI 44 usable in conjunction with the navigation system 10. As illustrated, the text-based window 46 includes a text-area 52 that corresponds to a query generated by a user and sent to the AI engine 20 for search (in the manner described above). Accordingly, text-area 52 can be shaded to represent that it is not editable and represents a past input from the user. Result-area 54 is also illustrated as part of text-based window 46. The result-area 54 includes a text-based response generated by the AI engine 20 in response to the user query submitted (as represented in text-area 52). In some embodiments, at least a portion of the text-based response (e.g., text-based results) is selectable by a user. In one embodiment, a user can select a portion of the text-based response in the result-area 54 and a window with more detailed information related to the selected result can be generated. Alternatively, selection of a portion of the text-based response in the result-area 54 will result in a new view being presented to the user with more detailed text about the selected item.

As additionally illustrated, the graphical window 48 can include a graphical representation 56. As illustrated, the graphical representation 56 is an image. However, other types of representations can be generated in the graphical window 48. For example, graphs, charts, or other visual indications can be generated in the graphical window 48. Likewise, audio and/or video responses as representations can also be generated. The graphical representation 56 is related to the result generated and presented in the result-area 54. In this manner, the GUI 44 generates both a text-based response and a graphical response that each corresponds to one another (as well as the underlying data searched by the AI engine 20).

In some embodiments, at least a portion of the graphics-based response (e.g., graphical representation 56) is selectable by a user. In one embodiment, a user can select a portion of the graphical representation 56, for example, icon 58, which corresponds to a particular operation related to the query by the user. Selection of icon 58 may result in the generation of a window with more detailed information related to the selected icon 58. Alternatively, selection of a portion of the graphical representation 56, for example, icon 58, will result in a new view being presented to the user with more detailed text about the selected item. In some embodiments, when audio and/or video responses are generated as representations, a user can similarly interact with the audio and/or video responses.

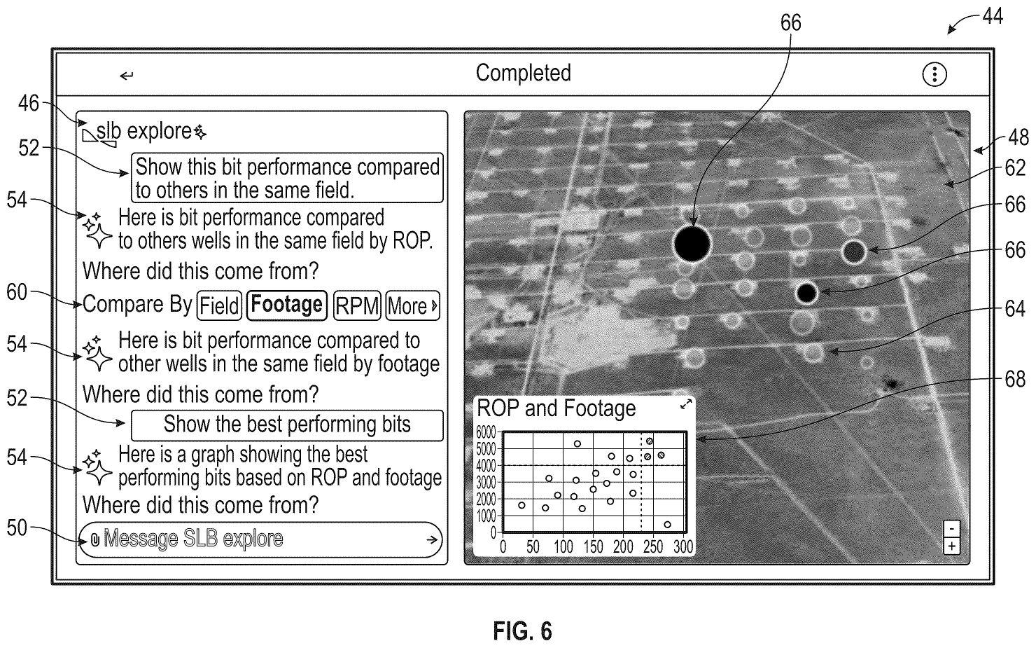

FIG. 6 is an example illustration of a third view of GUI 44 usable in conjunction with the navigation system 10. As illustrated, the text-based window 46 includes text-area 52 (i.e., the uppermost illustrated text-area 52) that corresponds to a query generated by a user and sent to the AI engine 20 for search (in the manner described above). Result-area 54 (i.e., the uppermost illustrated result-area 54 that is located directly below the uppermost illustrated text-area 52) is also illustrated as part of text-based window 46. The result-area 54 includes a text-based response generated by the AI engine 20 in response to the user query submitted (as represented in text-area 52).

As noted above, in some embodiments, at least a portion of the text-based response (e.g., text-based results) is selectable by a user. As illustrated in FIG. 6, icons 60 may be a part of and/or associated with the result-area 54 (i.e., the uppermost illustrated result-area 54 that is located directly below the uppermost illustrated text-area 52) and may be selectable by a user. In addition to generation of results in the text-based window 46, (e.g., concurrently with generation of results in the text-based window 46), the graphical window 48 can be updated to include a graphical representation 62. As illustrated, the graphical representation 62 is an image. However, other types of representations can be generated in the graphical window 48. The graphical representation 62 is related to the result generated and presented in the result-area 54 (i.e., the uppermost illustrated result-area 54). For example, icons 64 can be generated as part of the graphical representation 62 that corresponds to the result-area 54 (i.e., the uppermost illustrated result-area 54). In some embodiments, the icons 64 may represent a user selectable portion of the graphical window 48. In this manner, the GUI 44 generates both a text-based response and a graphical response that each corresponds to one another (as well as the underlying data searched by the AI engine 20). Furthermore, in some embodiments, audio and/or video responses can be generated in addition to (or in place of) the text-based response and a graphical response.

As noted above, icons 60 may be a selectable part of and/or associated with the result-area 54 (i.e., the uppermost illustrated result-area 54 that is located directly below the uppermost illustrated text-area 52). Selection of one of the icons 60 (illustrated via shading of the selected icon of the icons 60) may allow for generation of a result-area 54 (i.e., the second most upper illustrated result-area 54 that is located directly below the icons 60) in the text-based window 46.

Concurrently with generation of the result-area 54 (i.e., the second most upper illustrated result-area 54 that is located directly below the icons 60), the graphical window 48 can be updated to include alteration of the sizes of icons 64. That is, a selected icon of the icons 60 when selected corresponds to a query by the user to order the retrieved results by size (e.g., footage) and the AI engine provides the result-area 54 (i.e., the second most upper illustrated result-area 54 that is located directly below the icons 60) as well as alters the sizes or other aspects of icons 64 to generate icons 66 as differing from icons 64 to visually present the results to the user as a results subset.

As further provided in FIG. 6, a user may transmit an additional query (represented by bottommost illustrated text-area 52) with respect to a selected one icon 66 of the icons 66 (e.g., the right-most icon 66, as identified by a visual indication differing from the remaining icons 66). In response, the AI engine 20 may transmit a result illustrated in the GUI 44 result-area (i.e., the lowermost illustrated result-area 54). In connection with display of the result-area 54 (i.e., the lowermost illustrated result-area 54), the GUI 44 provides a graphical response associated with the text-based response (i.e., the lowermost illustrated result-area 54). This graphical response can be inclusion of window 68 in the graphical representation 62. Furthermore, the window 68 can include visual representations of the icons 64 for additional review by the user. The result(s) that the AI engine 20 generates may be filtered so as to guide a user. That is, the AI engine 20 may receive queries from a user and may operate to filter the queries so as to provide results that are predictively selected in a manner to guide a user to the information that the AI engine 20 associates with the query. That is, the AI engine 20 can determine, based on the query, actual results requested by a user such that separate queries can be determined by the AI engine to be related to a similar request and that determination can elicit generation of a common response to the separate queries. In this manner, the AI engine 20 can provide common determined prioritized results for separate queries when the AI engine 20 determines that the common queries are related (e.g., overlap).

As discussed above, the GUI 44 provides both text-based responses and graphical responses (and audio and/or video responses, in some embodiments) to user queries to allow for ease of review of the underlying retrieved data by the AI engine 20. Additionally, in some embodiments, the AI engine 20 may be trained and/or retrained based on feedback on the types of text-based responses and graphical responses that are determined to provide desired information to the user in response to particular queries. This may allow for the AI engine to be updated to provide more relevant results to users over time.

The techniques and systems described above can be useful in a number of areas. For example, the navigation system 10 and the AI engine 20 can be applied to data sources 14 that include historical and/or real-time data associated with, for example, natural resource operations (e.g., drilling operations, production operations, well construction, wireline operations, reservoir characterization operations, or the like), geothermal operations, carbon capture and storage operations, and/or reusable energy operations (e.g., solar power, wind power, etc.). Thus, the data can include geological data, equipment specifications, product specifications, locational data (e.g., geolocation information corresponding to a determined physical location, which can correspond to wells that are being drilled or otherwise operated on in a field or region), telemetry data, customer legacy data (e.g., historical customer data accessible only by that customer for a particular geographic region or a particular application/operation), client legacy data (e.g., historical data by the provider of the navigation system 10 that is determined to be accessible to a particular client), etc. For example, one or the data sources 14 can include geolocations (i.e., determined physical locations) of wells that are being drilled or otherwise operated on in a field or region. The AI engine 20 may utilize the physical location of the wells in generating suggestions on risks and/or risk management for operations, such as real-time operations. The AI engine 20 can operate to combine historical (e.g., archived) data with acquisition systems data (e.g., real-time acquired data) in generating the suggestion. The geolocation of the well can be tied to the actual operations of that well and historical data from that same well using the navigation system and the results can be rendered via the GUI 44. For example, the navigation system can receive a query from a user requesting suggestions on what would be the best approach to prevent an incident under current conditions being experienced at a given well (e.g., well X). The current conditions experienced at well X would be real-time data acquired via an acquisition system at well X as a data source 14. The AI engine 20 would have access to this data, as well as, for example, real-time data and historical data related to well X (as identified by its geolocation data (e.g., within a respective Geo Fence of a predetermined or selected distance surrounding well X). The AI engine 20, in this manner, would be able to search and apply the relevant data as identified by a geolocation tag associated with the data in generating its suggestions for one or more approaches to prevent an incident. The results generated by the AI engine 20 and provided via the GUI 44 could include, for example, results for risks at intervals of respective depths. The AI engine 20 could further provide suggested remedial actions and/or offer to contact outside support entities for assistance, as well as contact a determined support party when the option requesting assistance is chosen.

Efficiencies can also be improved through the use of the navigation system 10 inclusive of the AI engine 20. For example, based on the geolocation of wells, the AI engine 20 can operate to provide an estimated consumption of products for operations, using the input of upcoming activity in the area identified by the geolocation information. A user might query the AI engine 20 via the GUI 44 asking for the estimated consumption of products and associated cost, using current and legacy data and include current and upcoming applicable technologies in the portfolio. The AI engine 20 would be able to utilize data (associated with particular geolocation data) of previous projects to determine costs and consumption of products of projects that the AI engine 20 determines will be performed at a particular geolocation. Utilizing this data, the AI engine 20 could, for example, generate and display (on the GUI 44) a table or other visual indicator comparing the potential cost (estimated) of products consumption for projects to be undertaken at a particular geolocation. The AI engine 20 could further generate a prompt asking if a service order should be initiated in view of the generated result. The AI engine 20 could additionally generate and/or transmit a request for service (e.g., a service order) to the properly determined parties if a user elects to choose the option requesting services.

In other potential embodiments, the navigation system 10 inclusive of the AI engine 20 can operate to receive and use the geolocation of equipment and data indicative of subsurface conditions to which that equipment is being exposed as data sources 14. The navigation system 10 can operate to perform a predictive analysis using data, such as the most recently generated maintenance ticket(s), repairs or failures experienced on this type of equipment under similar conditions, and the like. Thus, if a user generates a query for the AI engine 20 to run a predictive analysis using the latest information available with respect to equipment at a selected location and current subsurface data, the AI engine 20 can operate to provide suggestions to extend the life of the equipment and/or provide notice if other actions are warranted. This analysis performed by the AI engine can utilize data for the particular well at the given geolocation, such as the most recently generated maintenance ticket(s), repairs, etc. and/or failures experienced on the type of equipment at the particular geolocation when exposed to similar conditions, and the like. The AI engine 20 can operate to generate and provide (via the GUI 44) suggestion(s) to extend the life of the equipment and/or suggest other actions if warranted. For example, the AI engine can generate a result providing an estimated time of repair or failure of equipment and/or a lifespan of the equipment, one or more suggestions to follow to address the results, and/or replacement options. In some embodiments, in conjunction with the generated results, the AI engine 20 can provide details of the latest agreement in place for maintenance or repair with a particular vendor, options for a vendor for equipment replacement, as well as a selectable option for the AI engine 20 to generate and/or transmit a request for a new quote (for repair or replacement of the equipment).

In other embodiments, the navigation system 10 inclusive of the AI engine 20 can operate to provide multiple scenario generation and reviews (e.g., answers to “what if” or other postulated scenarios). For example, using a determined geolocation, the AI engine 20 can operate to combine subsurface data to determine a preferred outcome of a service, equipment, or product as well as performed via an iterative process to generate multiple solutions in combination for the specificity of a request. A query can be generated with respect to a particular geo fence (e.g., a 50-mile radius about a set of wells including well X, well X1, well X2, and well X3. The AI engine 20 can operate to run multiple scenarios of combination of equipment, parameters, and services to improve the production of the assets (e.g., well X, X1, X2, and X3). This simulation can be performed in parallel, and the results can be analyzed by the AI engine 20 and one or more selected combinations can be generated and provided via the GUI 44 in a prioritized (e.g., ranked) list according to, for example, particular weighted criteria. For example, the results can be generated as prioritizing well production output (e.g., barrels of oil produced per day). The AI engine 20, using the weighted criteria and conditions present for the assets in the identified geo fence can operate to generate a visual indication (e.g., a table or list) of the suggested equipment, parameters, and suggested services for each asset. The generated result can account for (i.e., include), for example, the current fleet of equipment available. Additionally, in some embodiments, the AI engine 20 can also suggest that customized equipment could be designed and can operate to generate and/or transmit a design request for new equipment to increase gains in the generated results.

The technical effect of the disclosed embodiments includes an improvement in data management, navigation, summarization, and/or visualization. Indeed, the navigation system 10 efficiently navigates reports of the one or more entities by retrieving, extracting, splitting and summarizing, and/or processing the set of data to provide comprehensive responses to the user queries via the report navigator user interface 100. Further, the navigation system 10 may automatically collect the data from the one or more data sources and build a comprehensive database including the data for efficient retrieval and analysis at a subsequent time. The navigation system 10 may enable dynamic and real-time report navigation that provides responses (e.g., answers) to user queries, while also providing the one or more entities with actionable insights.

The subject matter described in detail above may be defined as set forth below.

According to a first aspect, a system, includes a processing system including an artificial intelligence (AI) engine. The processing system is configured to receive a set of data from a data source, divide the set of data into one or more subsets of data, transmit the one or more subsets of data to the AI engine, transmit one or more queries to the AI engine to elicit search and identification of one or more responses based on a data set including the one or more subsets of data, wherein the one or more responses include a text-based response and a graphical response associated with the text-based response, and transmit the text-based response and the graphical response to a graphical user interface for presentation on a display of an electronic device including the graphical user interface.

The system of the preceding clause, wherein the processing system is further configured to receive a second set of data.

The system of any of the preceding clauses, wherein the processing system is further configured to receive the second set of data from a second data source as real-time acquired data.

The system of any of the preceding clauses, wherein the processing system is further configured to receive the second set of data in parallel with receiving the set of data.

The system of any of the preceding clauses, wherein the processing system is further configured to divide the second set of data into one or more second subsets of data in parallel with dividing the set of data into one or more subsets of data.

The system of any of the preceding clauses, wherein the processing system is further configured to divide the second set of data into one or more second subsets of data, transmit the one or more second subsets of data to the AI engine, and elicit search and identification of the one or more responses based on the data set as additionally including the one or more second subsets of data.

The system of any of the preceding clauses, wherein the processing system is further configured to receive an indication of a user input from the graphical user interface as a second query.

The system of any of the preceding clauses, wherein the AI engine of the processing system is configured to search the data set and identify one or more second responses, wherein the one or more second responses include a second text-based response and a second graphical response associated with the second text-based response, and transmit the second text-based response and the second graphical response to the graphical user interface for presentation on the display.

The system of any of the preceding clauses, wherein the AI engine of the processing system is configured to determine whether the second query overlaps with an additional query and generate one or more second responses related to the second query and the additional query as a guided response.

The system of any of the preceding clauses, wherein the one or more responses include an audio response or a video response, wherein the wherein the processing system is further configured to transmit the audio response or the video response to the graphical user interface for presentation on the display.

The system of any of the preceding clauses, wherein the processing system is further configured to transmit the one or more queries to the AI engine to elicit search and identification of at least one approach to prevent an incident at an asset located at a particular geolocation as the one or more responses.

The system of any of the preceding clauses, wherein the processing system is further configured to transmit the one or more queries to the AI engine to elicit search and identification of estimated consumption of products and associated cost at an asset located at a particular geolocation as the one or more responses.

The system of any of the preceding clauses, wherein the processing system is further configured to transmit the one or more queries to the AI engine to elicit search and identification of life expectancy of equipment at an asset located at a particular geolocation, to elicit identification of a timing or type of repair of the equipment, or to elicit identification of one or more replacement options for replacement of the equipment as the one or more responses.

The system of any of the preceding clauses, wherein the processing system is further configured to transmit the one or more queries to the AI engine to elicit identification of combinations of equipment, parameters, and services to improve production of assets in a geo fence region as the one or more responses.

According to a second aspect, a method includes receiving a set of data from a data source, dividing the set of data into one or more subsets of data, transmitting the one or more subsets of data to an artificial intelligence (AI) engine, transmitting one or more queries to the AI engine to elicit search and identification of one or more responses based on a data set including the one or more subsets of data, wherein the one or more responses include a text-based response and a graphical response associated with the text-based response, and transmitting the text-based response and the graphical response to a graphical user interface for presentation on a display of an electronic device including the graphical user interface.

The method of preceding clause, further including receiving a second set of data from a second data source as real-time acquired data.

The method of any of the preceding clauses, further including dividing the second set of data into one or more second subsets of data, transmitting the one or more second subsets of data to the AI engine, and eliciting search and identification of the one or more responses based on the data set as additionally including the one or more second subsets of data.

According to a third aspect, a tangible, non-transitory, computer-readable medium includes instructions that, when executed by processing circuitry, are configured to cause the processing circuitry to receive a set of data from a data source, divide the set of data into one or more subsets of data, transmit the one or more subsets of data to the AI engine, transmit one or more queries to the AI engine to elicit search and identification of one or more responses based on a data set including the one or more subsets of data, wherein the one or more responses include a text-based response and a graphical response associated with the text-based response, and transmit the text-based response and the graphical response to a graphical user interface for presentation on a display of an electronic device including the graphical user interface.

The tangible, non-transitory, computer-readable medium of the preceding clause, further including instructions that, when executed by the processing circuitry, are configured to cause the processing circuitry to receive an indication of a user input from the graphical user interface as a second query.

The tangible, non-transitory, computer-readable medium of any of the preceding clauses, further including instructions that, when executed by the processing circuitry, are configured to cause the processing circuitry to search the data set and identify one or more second responses, wherein the one or more second responses include a second text-based response and a second graphical response associated with the second text-based response, and transmit the second text-based response and the second graphical response to the graphical user interface for presentation on the display.

The foregoing description, for purpose of explanation, has been described with reference to specific embodiments. However, the illustrative discussions above are not intended to be exhaustive or to limit the disclosure to the precise forms disclosed. Refinements of the features noted above may exist in relation to various aspects of the present disclosure. Many modifications and variations are possible in view of the above teachings. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination.

Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosure and various embodiments with various modifications as are suited to the particular use contemplated.

1. A system, comprising:
a processing system comprising an artificial intelligence (AI) engine, wherein the processing system is configured to:
receive a set of data from a data source;
divide the set of data into one or more subsets of data;
transmit the one or more subsets of data to the AI engine;
transmit one or more queries to the AI engine to elicit search and identification of one or more responses based on a data set comprising the one or more subsets of data, wherein the one or more responses include a text-based response and a graphical response associated with the text-based response; and
transmit the text-based response and the graphical response to a graphical user interface for presentation on a display of an electronic device comprising the graphical user interface.

2. The system of claim 1, wherein the processing system is further configured to receive a second set of data.

3. The system of claim 2, wherein the processing system is further configured to receive the second set of data from a second data source as real-time acquired data.

4. The system of claim 3, wherein the processing system is further configured to receive the second set of data in parallel with receiving the set of data.

5. The system of claim 3, wherein the processing system is further configured to divide the second set of data into one or more second subsets of data in parallel with dividing the set of data into one or more subsets of data.

6. The system of claim 3, wherein the processing system is further configured to:
divide the second set of data into one or more second subsets of data;
transmit the one or more second subsets of data to the AI engine; and
elicit search and identification of the one or more responses based on the data set as additionally comprising the one or more second subsets of data.

7. The system of claim 1, wherein the processing system is further configured to receive an indication of a user input from the graphical user interface as a second query.

8. The system of claim 7, wherein the AI engine of the processing system is configured to:
search the data set and identify one or more second responses, wherein the one or more second responses include a second text-based response and a second graphical response associated with the second text-based response; and
transmit the second text-based response and the second graphical response to the graphical user interface for presentation on the display.

9. The system of claim 7, wherein the AI engine of the processing system is configured to determine whether the second query overlaps with an additional query and generate one or more second responses related to the second query and the additional query as a guided response.

10. The system of claim 1, wherein the one or more responses include an audio response or a video response, wherein the wherein the processing system is further configured to transmit the audio response or the video response to the graphical user interface for presentation on the display.

11. The system of claim 1, wherein the processing system is further configured to transmit the one or more queries to the AI engine to elicit search and identification of at least one approach to prevent an incident at an asset located at a particular geolocation as the one or more responses.

12. The system of claim 1, wherein the processing system is further configured to transmit the one or more queries to the AI engine to elicit search and identification of estimated consumption of products and associated cost at an asset located at a particular geolocation as the one or more responses.

13. The system of claim 1, wherein the processing system is further configured to transmit the one or more queries to the AI engine to elicit search and identification of life expectancy of equipment at an asset located at a particular geolocation, to elicit identification of a timing or type of repair of the equipment, or to elicit identification of one or more replacement options for replacement of the equipment as the one or more responses.

14. The system of claim 1, wherein the processing system is further configured to transmit the one or more queries to the AI engine to elicit identification of combinations of equipment, parameters, and services to improve production of assets in a geo fence region as the one or more responses.

15. A method, comprising:
receiving a set of data from a data source;
dividing the set of data into one or more subsets of data;
transmitting the one or more subsets of data to an artificial intelligence (AI) engine;
transmitting one or more queries to the AI engine to elicit search and identification of one or more responses based on a data set comprising the one or more subsets of data, wherein the one or more responses include a text-based response and a graphical response associated with the text-based response; and
transmitting the text-based response and the graphical response to a graphical user interface for presentation on a display of an electronic device comprising the graphical user interface.

16. The method of claim 15, further comprising receiving a second set of data from a second data source as real-time acquired data.

17. The method of claim 16, further comprising:
dividing the second set of data into one or more second subsets of data;
transmitting the one or more second subsets of data to the AI engine; and
eliciting search and identification of the one or more responses based on the data set as additionally comprising the one or more second subsets of data.

18. A tangible, non-transitory, computer-readable medium comprising instructions that, when executed by processing circuitry, are configured to cause the processing circuitry to:
receive a set of data from a data source;
divide the set of data into one or more subsets of data;
transmit the one or more subsets of data to the AI engine;
transmit one or more queries to the AI engine to elicit search and identification of one or more responses based on a data set comprising the one or more subsets of data, wherein the one or more responses include a text-based response and a graphical response associated with the text-based response; and
transmit the text-based response and the graphical response to a graphical user interface for presentation on a display of an electronic device comprising the graphical user interface.

19. The tangible, non-transitory, computer-readable medium of claim 18, further comprising instructions that, when executed by the processing circuitry, are configured to cause the processing circuitry to receive an indication of a user input from the graphical user interface as a second query.

20. The tangible, non-transitory, computer-readable medium of claim 19, further comprising instructions that, when executed by the processing circuitry, are configured to cause the processing circuitry to:
search the data set and identify one or more second responses, wherein the one or more second responses include a second text-based response and a second graphical response associated with the second text-based response; and
transmit the second text-based response and the second graphical response to the graphical user interface for presentation on the display.
